(19) United States
(12) Patent Application Publication
(10) Pub. No.: US 2026/0319845 A1
(43) Pub. Date: Oct. 15, 2026

(54) AUTOMATED PROMPTING TECHNIQUES FOR CONTENT CONVERSION FROM UNSTRUCTURED DATA

(71) Applicant: Optum, Inc., Minnetonka, MN (US)

(72) Inventors: Vipul Garg, Plymouth, MN (US); Aman Gupta, Meerut (IN); Meenakshi Gupta, Bangalore (IN); Sumant Khebbani, Hyderabad (IN); Kedar Bhumkar, Eden Prairie, MN (US); Pankaj Raherkar, Pune (IN)

(21) Appl. No.: 19/175,637

(22) Filed: Apr. 10, 2025

(51) Int. Cl. G06F 9/50; G06F 9/54

(52) U.S. Cl. CPC G06F 9/5027; G06F 9/547

(57) ABSTRACT

Various embodiments of the present disclosure provide an automated content conversion technique that improves the functionality of a computer in various aspects. The techniques comprise receiving an API request for a language model and that identifies source content and a data conversion task for a language model and a webpage; determining a set of prompt-specific instructions for the language model based on the data conversion task; generating an initial prompt based on the source content and the set of prompt-specific instructions; generating, using the language model, a structured data response based on the initial prompt; and providing the structured data response to auto-populate a set of form data objects associated with the webpage.

### BACKGROUND

In many domains, web interfaces and other online platforms are used to record data through the use of structured data objects, such as JavaScript objects, Hypertext Markup Language elements, and/or the like. Structured data objects provide useful tools for the manual entry of data at the expense of interactions with natural language or other non-structured mediums, such as imagery, speech, speech transcripts, and/or the like. The lack of interactivity between structured data and natural language traditionally hinders the use of sophisticated language processing tools, such as generative models, with web interfaces and/or other implementations of structured data (e.g., content controlled documents). Thus, traditional approaches for integrating non-structured data into structured data elements typically require extensive manual configuration and frequent updates to maintain accuracy, leading to increased operational costs and reduced efficiency of natural language processing tools.

### BRIEF DESCRIPTION OF THE DRAWINGS

FIG. 1 depicts an example overview of an architecture in accordance with some embodiments of the present disclosure.

FIG. 2 depicts an example predictive data analysis computing entity in accordance with some embodiments of the present disclosure.

FIG. 3 depicts an example client computing entity in accordance with some embodiments of the present disclosure.

FIG. 4 depicts a dataflow diagram an automated content conversion technique in accordance with some embodiments of the present disclosure.

FIG. 5A and 5B each depict a dataflow diagram of an example automated prompt engineering technique in accordance with some embodiments of the present disclosure.

FIG. 6 depicts a flowchart diagram of an example automated content conversion process in accordance with some embodiments of the present disclosure.

FIG. 7 depicts a flowchart diagram of an example prompt engineering process in accordance with some embodiments of the present disclosure.

### DETAILED DESCRIPTION

Various embodiments of the present disclosure provide automated prompting techniques that improve the functionality of a computer with respect to content conversion and the application of language models in various structured data contexts. To do so, some embodiments of the present disclosure provide a task execution service that automatically adapts unstructured content of any type (e.g., imagery, audio, text) into one or more initial prompts for a language model. Using the techniques of the present disclosure, the initial prompts may integrate the unstructured content with a set of return data constraints to guide the language model in a content conversion process to structured data elements within a structured data object. The set of return data constraints, for example, may be tailored to a webpage, content-controlled document, and/or any other implementation of a structured data object to facilitate the automatic extraction of content for up to each of a set of structured data elements within the object. To address context size thresholds of any language model, the task execution service may determine a prompt complexity score that it uses to determine whether to slice initial prompts into a set of prompt slices that improve the thoroughness, accuracy, and speed of the language model. The task execution service may receive responses to the initial prompts and, in response to the responses, synthesize the extracted content with structured data fields (e.g., by storing pieces of the extracted content in accordance with different structured formats) and return the resulting structured data elements for integration with the structured data object. By doing so, the techniques of the present disclosure may leverage automated prompting techniques to adapt language models for a structured data content conversion process. This, in turn, improves the speed, efficiency, and scalability of content conversion, while also addressing technical challenges with language models, such as hallucinations, by mapping extracted data with structured data fields that may verified in a computationally efficient manner (e.g., through user review, text matching tools). In this regard, embodiments of the present disclosure provides techniques that overcome hallucinations and scalability limitations associated with traditional techniques and traditional natural language processing models.

More specifically, some embodiments of the present disclosure may define a sequence of language model preprocessing and postprocessing interactions to iteratively generate structured outputs with optimized computing resources. To overcome performance deficiencies with traditional natural language processing models, such as generative models, the sequence of language model preprocessing interactions may implement a selective prompt slicing approach to dynamically tailor prompt complexity to the limitation of any language model. By doing so, some embodiments of the present disclosure may address traditional limitations with generative models by reducing hallucinations, overcoming context window size constraints, increasing the scalability of model inputs, among other technical limitations associated with language models through a flexible architecture that enables the integration of any language model regardless of the language context sizes, or other processing parameters. This, in turn, enables improved content conversion that, unlike traditional techniques, may handle inputs of varying complexity without reductions in accuracy, speed, or thoroughness. Such improvements directly improve the performance of generative models, among other technical advantages.

Traditional content conversion techniques often lack the ability to efficiently handle complex, unstructured inputs, which leads to inefficiencies and inaccuracies in data processing. The multi-stage process of the present disclosure leverages a series of complementary prompting components to address these deficiencies. By doing so, the multi-stage prompting techniques of the present disclosure may enable the creation and maintenance of a universal translation service between unstructured textual inputs and structured data outputs. By automating the process, the universal translation service may continuously iterate and, by doing so, augment input-output mappings over time to adapt to changes within any implementation of structured data, including webpages, content-controlled documents, and/or the like. This ensures that the structured outputs associated with unstructured inputs are always accurate and up-to-date.

Examples of technologically advantageous embodiments of the present disclosure comprise a modification to traditional prompting methodologies to integrate language models with structured data objects, such as webpages, among others. This allows for hybrid manifestations of structured data objects that may dynamically produce structured data elements from unstructured inputs, among other aspects of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

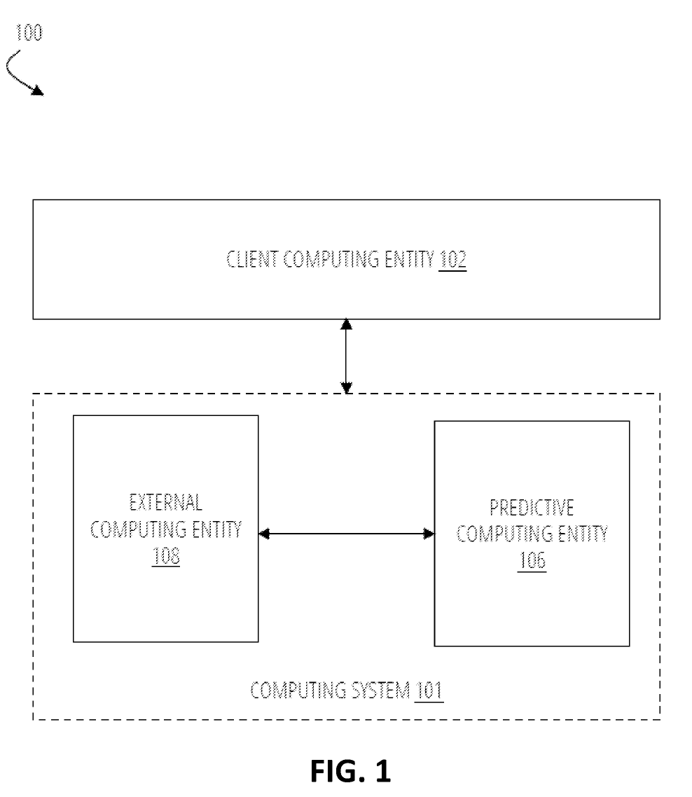

FIG. 1 depicts a block diagram of an example architecture 100 in accordance with some embodiments of the present disclosure. The architecture 100 comprises a computing system 101 configured to receive a request, such as an API request or other form of request, from client computing entities 102, process the request to generate an output, and provide the output to the client computing entities 102. A non-limiting example of such other form of request is a command line interface (CLI) request. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate prompt complexity scores, structured data responses and/or other machine learning outputs. The models may be adapted to an automated content conversion framework comprising data conversion techniques, prompt engineering techniques, and response mapping techniques. Some techniques of the present disclosure may adapt traditional models to a cohesive framework, such as the automated content conversion framework for more efficiently handling portions of the automated content conversion process.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate predictions, and provide the predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., data conversion techniques, prompt engineering techniques, response mapping techniques, transcription techniques such as voice to text transcription techniques, and/or other techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as source content, model data, training data, and/or the like to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

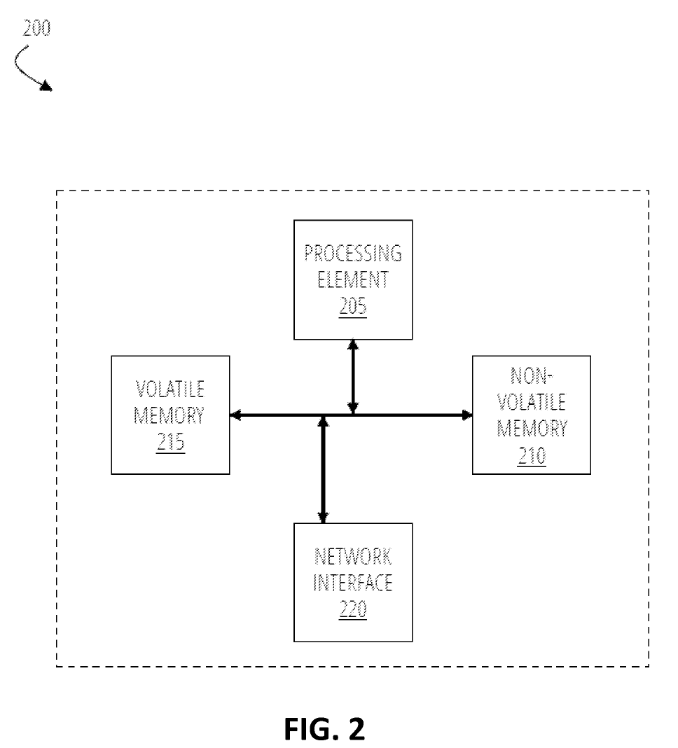

FIG. 2 depicts an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile memory 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

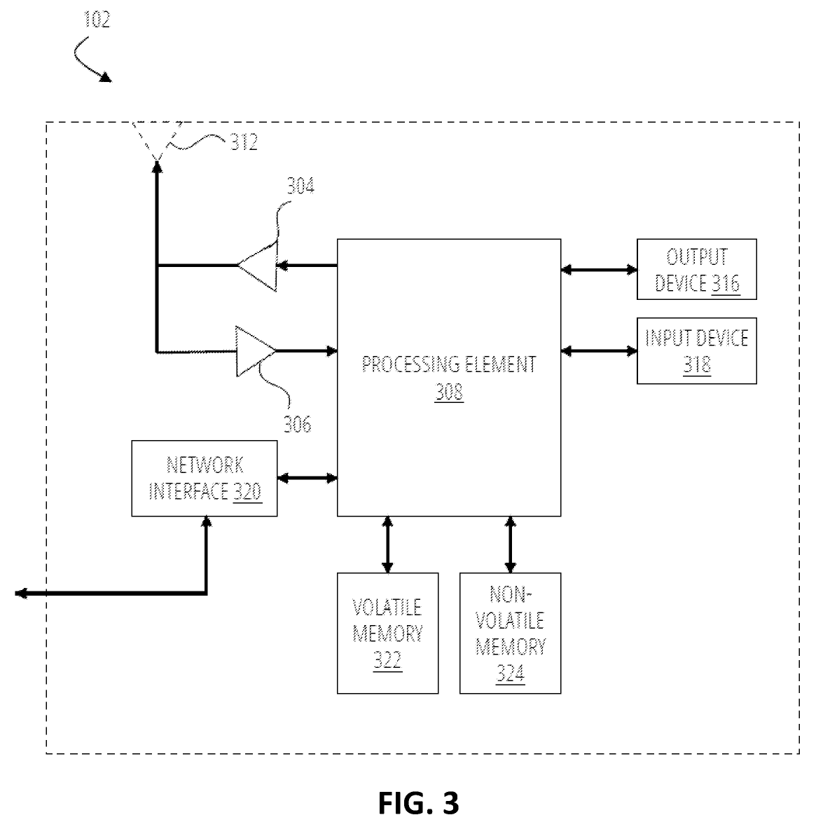

FIG. 3 depicts an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to content extraction, processing, and conversion, as well as the processing capabilities of language models. In particular, systems and methods are disclosed herein that implement automated content conversion techniques that improve data conversion operations relative to traditional approaches. By doing so, the automated content conversion techniques of the present disclosure enable improved data conversions that, when executed on a computer, improves the capabilities of a computer with respect to the execution of language models and the interpretability, handling, and storage of unstructured data. This, in turn, may improve the functionality of a computer with respect to various computing tasks, including data ingestion, machine learning, network communication, and the like.

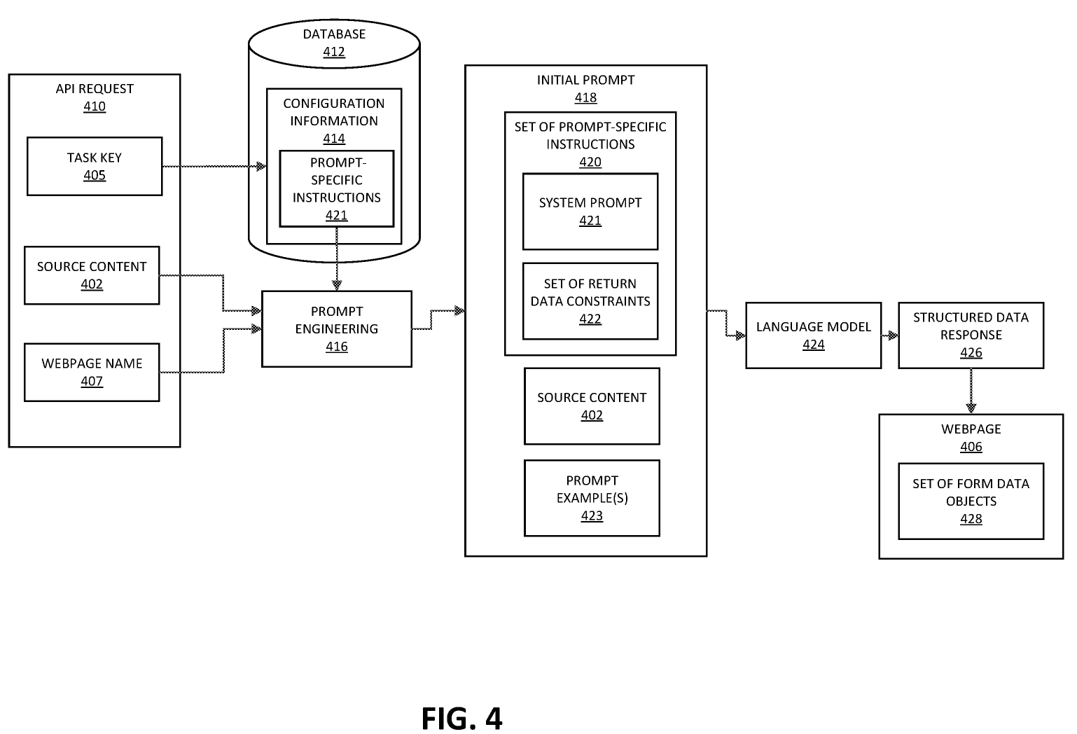

FIG. 4 depicts a dataflow diagram 400 of an example automated content conversion technique in accordance with some embodiments of the present disclosure. As depicted, the automated content conversion technique applies a data conversion approach to extract structured data elements from unstructured source content 402. For example, using techniques of the present disclosure, the computing system 101 (and/or a task execution service thereof) may engineer prompts comprising prompt-specific instructions that guide a language model through the performance of a targeted data conversion task for a structured data object. This, in turn, may be leveraged with various structured data objects to auto-populate form fields among other practical applications. By doing so, the automated content conversion techniques of the present disclosure may enable the integration of natural language processing with structured data elements, which may improve the efficiency of content conversion while improving the detection of hallucinations and other errors by the language models. In addition, and as described in further detail herein, the automated content conversion techniques of the present disclosure may be adapted to any language model through a prompt slicing approach that may leverage a prompt complexity score to selectively apply a prompt processing strategy that accounts for the limitations of the language model (e.g., context window, token length, and/or the like).For example, as further described herein, sequential prompt processing strategy or parallel prompt processing strategy may be selected for processing an initial prompt based on a prompt complexity score for the initial prompt.

In some embodiments, the task execution service comprises a component of the computing system 101 that manages and executes various tasks or operations associated with automated content conversion, as described herein. The task execution service may be implemented as a software module or component running on one or more processors of a computing system. It may interact with other components such as databases, APIs, and language models to carry out one or more functions. The task execution service may be configured for receiving and processing request (such as API requests, CLI requests, or other form of request) that identify source content and data conversion tasks. The task execution service may be configured to parse the requests to extract relevant information and retrieve corresponding configuration information from a configuration database. This configuration information may include prompt-specific instructions, model parameters, and other configuration information for interacting with a language model.

The task execution service may employ prompt engineering techniques to craft effective prompts that guide the language model in performing data conversion tasks. The task execution service may be configured determine a prompt complexity score, and leverage the prompt complexity score to determine whether to process the prompt sequentially or split the prompt into multiple prompt slices for parallel processing. The task execution service may be configured to process the output of the language model. Such process may comprise combining responses from multiple prompt slices if parallel processing was used. The task execution service may be configured to provide structured data response output by the language model to auto-populate form fields or other data objects associated with a webpage or application.

In some embodiments, the computing system 101 receives a request for a language model 424 and that identifies source content 402 and a data conversion task for the language model 424 and a webpage 406. Such request may be an API request, a CLI request, or other form of request. In some embodiments, the computing system 101 receives an API request 410 for a language model 424 and that identifies source content 402 and a data conversion task for the language model 424 and a webpage 406. In some embodiments, the computing system 101 may authenticate the API request 410 in response to receiving the API request.

In some embodiments, the API request 410 comprises a structured communication sent to an API to request data and/or a functionality. For example, the API request 410 may be sent to an API associated with the computing system 101 to initiate an automated content conversion process that comprises a data conversion task. The API request 410 may be generated by a client-side application, such as a web browser or mobile application, and sent to the API endpoint. The client-side application may be hosted by and/or associated with a client computing entity 102.

The computing system 101 may expose a web service which the client-side application may call to pass the API request 410. The API request 410 may comprise the source content 402 from which relevant data is to be extracted via the data conversion task. Alternatively, or additionally, the API request 410 may comprise one or more items of data (e.g., task key 405) that identifies the data conversion task. Alternatively, or additionally, the API request 410 may comprise one or more items of data, such as a webpage name 407, that identifies the webpage 406. In some examples, the API request 410 may be formatted according to a predefined schema, using, for example, a format such as JavaScript Object Notation (JSON), Extensible Markup Language (XML), Avro, Parquet, plain text, and/or the like.

In some embodiments, the webpage 406 comprises a structured document, such as a structured form, accessible through a web browser. The structured document may comprise a set of form fields corresponding to a set of form fields of the webpage 406. For example, the structured document may be implemented as webpage 406 associated with a set of form data objects 428 corresponding to the set of form fields. The structured document may be transmitted over a network using protocols such as Hypertext Transfer Protocol (HTTP), HTTP Secure (HTTPS), and/or the like. In this regard, a structured document may be implemented as webpage 406 (e.g., web-based form). In one non-limiting example implementation, the structured document corresponds to an electronic health record (EHR) form such as, for example a Subjective, Objective, Assessment, Plan (SOAP) form. In another non-limiting example implementation, the structured document corresponds to computer activity form. It will be appreciated that the structured document may correspond to any of a variety of documents without departing from the scope of the present disclosure.

The webpage 406 may be associated with a file comprising code, such as for example Hypertext Markup Language (HTML) code, that defines the structure and content of the webpage 406. The webpage 406 may comprise text, images, videos, hyperlinks, and other multimedia elements that are renderable by a web browser, mobile application, and/or the like for user interaction. For example, the webpage 406 may serve as an interactive user interface where a user may input data such as source content 402, trigger voice transcription, interact with AI-generated outputs such as language model 424 outputs, and/or the like.

In some embodiments, source content 402 comprises unstructured text (e.g., call transcript such as medical transcripts, legal transcripts, or any other transcripts; activity report of a computer; and/or other unstructured text), audio, imagery, video, or any other media type. The source content 402 may comprise the subject of an automated content conversion process. For example, the source content 402 may serve as the input data from which relevant information is extracted to automatically populate a set of form data objects 428 associated with the webpage 406.

The technical handling of the source content 402 may comprise one or more sophisticated processes. By way of example, for unstructured text, natural language processing (NLP) techniques may be employed to parse and understand the semantic meaning of the text. This may comprise tokenization, part-of-speech tagging, named entity recognition, semantic analysis, and/or the like. By way of another example, for audio content, speech recognition algorithms may be employed to convert spoken words into unstructured text which may then be processed using NLP techniques and/or other techniques. By way of yet another example, for image and/or video content, computer vision algorithms may be employed to identify and extract relevant information.

In some embodiments, a data conversion task comprises transforming unstructured data into structured data for further processing or storage. For example, the data conversion task may comprise analysis of the unstructured source content 402 to detect relevant data from the source content 402, extract the relevant data, and output the relevant data in a structured format (e.g., JSON, XML, or the like) for auto-populating a set of form data objects 428 associated with a webpage 406. In this regard, outputting the relevant data in a structured format may allow for the mapping of the extracted data to form fields of the webpage 406 for auto-populating the corresponding set of form data objects 428 associated with the webpage 406.

The data conversion task may comprise utilization of one or more algorithms and/or techniques such as, natural language processing (NLP), machine learning, and/or the like. Such algorithms and/or techniques may comprise named entity recognition (NER) to identify specific types of information (e.g., names, dates, locations), part-of-speech tagging to understand the grammatical structure of text, semantic analysis to interpret the meaning and context of words and phrases, and/or the like. For example, implementation of the data conversion task may comprise, text preprocessing, application of one or more NLP models and/or techniques, and/or other processing steps. In some examples, the data conversion task comprises utilization of active learning techniques to improve the data conversion capabilities over time based on, for example, user feedback.

In some embodiments, the language model 424 comprises an artificial intelligence (AI) model configured to generate a structured data response for the source content 402. For example, the language model 424 may be a generative model implemented as an artificial neural network trained on vast amounts of text data to understand and generate unstructured data, such as natural language text, images, audio, and/or the like. In some examples, the language model 424 may be hosted on cloud computing infrastructure to handle the complex computations required for natural language processing and generation. The language model 424 may processes the input text (e.g., text from the source content 402) as a series of tokens to generate unstructured outputs.

The language model 424 may be configured to receive prompts that comprise the source content and specific instructions for the desired output format, which may be further processed and mapped to specific fields in the structured form (e.g., a webpage, content controlled document). The language model 424 may be configured to understand the context of the source content 402 and extract relevant data in a structured format, which allows for the automatic conversion of unstructured data to structured counterparts – a process that is traditionally outside the scope of language model. By leveraging the language model’s natural language understanding capabilities with the specific instructions, the computing system 101 may handle a wide variety of source content and structured form styles. In some examples, the language model may be a generative model (e.g., domain-agnostic generative model, domain-specific generative model trained on domain text), which may provide higher accuracy for certain prediction domains. The generative model, for example, may comprise a domain-specific generative model that, in a clinical context, may be trained on medical text. In some examples, multiple language models may be used in tandem.

In some embodiments, the computing system 101 determines a set of prompt-specific instructions 420 for the language model based on the data conversion task, where the set of prompt-specific instructions comprises one or more prompt-specific instructions. For example, the set of prompt-specific instructions 420 may comprise part of configuration information 414 for the data conversion task for interacting with the language model 424. In some examples, the configuration information 414 may comprise the set of prompt-specific instructions 420, model parameters (e.g., context window, maximum tokens, and/or the like), prompt examples, and/or other configuration information for interacting with the language model 424.

The computing system 101 may parse the API request 410 and leverage information obtained from the API request 410 to determine the set of prompt-specific instructions 420 and/or other configuration information 414 for the language model 424. For example, the computing system 101 may identify the task key 405 from the API request 410 and match the task key to a row in a configuration database, such as implemented as a relational database (e.g., PostgreSQL database or the like), corresponding to the task key 405 and comprising the configuration information 414 for the data conversion task for interacting with the language model 424. For example, the configuration information 414 may be maintained in the configuration database 412 in association with the task key 405. As described above, in some embodiments, the request received by the language model 424 may be a CLI request or other form of request. In such some embodiments, the computing system 101 may parse the CLI request (or other form of request) to determine the set of prompt-specific instructions 420 and/or other configuration information 414 for the language model 424 as described above.

In some embodiments, the set of prompt-specific instructions 420 comprises instructions for directing and/or guiding a language model 424 to perform the data conversion task. The set of prompt-specific instructions 420 may help to focus the language model 424 on relevant parts of the source content 402, specify the desired format for the extracted data, and/or may comprise rules for handling edge cases and/or specific data types. For example, the set of prompt-specific instructions 420 may be designed to direct the behavior of the language model 424 specifically tailoring the output of the language model 424 to meet the expectations of the data conversion task. The set of prompt-specific instructions 420 may guide the language model 424 to extract relevant information from source content 402 and to format the extracted information in a manner that facilitates, supports, and/or enables accurate mapping of the extracted information to a set of form fields of a webpage 406 to auto-populate corresponding set of form data objects 428 associated with the webpage 406. In this regard, the set of prompt-specific instructions 420 may act as a bridge between the unstructured source content 402 and the structured output to facilitate, support, and/or enable accurate mapping of the extracted data to the set of form fields. Specifically, the set of prompt-specific instructions 420 may be designed to enable transformation of unstructured data to structured data.

The technical implementation of the set of prompt-specific instructions 420 may comprise careful engineering using a combination of domain-specific knowledge and general language model best practices. For example, the set of prompt-specific instructions 420 may comprise a system prompt 421 and a set of return data constraints 422, wherein the system prompt 421 comprises text that directs the language model 424 to perform a data conversion task based on the source content 402 and to provide an output in accordance with the set of return data constraints 422. For example, the system prompt 421 may inform the behavior of the language model 424 (e.g., tell the language model 424 how to behave). The set of return data constraints 422 may serve as a blueprint for the desired structured output. For example, the set of return data constraints 422 may identify the response output formats and/or expected response type for individual form fields. In this regard, the set of return data constraints 422 mitigates against hallucination by the language model 424 and guides the language model 424 to provide appropriate response in the desired format. This in turn allows for mapping of the extracted data to the set of form fields of the webpage 406 such that the unstructured source content 402 is transformed into appropriate structured data for auto-populating the set of form data objects 428 associated with the webpage 406. The set of return data constraints 422 may be determined based on the specific data conversion task and/or the webpage 406 (e.g., the structured form implemented as a webpage). Alternatively, or additionally, in some embodiments, the prompt-specific instructions 420 may comprise special instructions. Such special instructions may inform the language model 424 how to behave if it comes across certain data in the source content, certain source content format, and/or the like for edge cases/exception use cases.

In some embodiments, the content, length of instructions, and/or structure/format of the prompt-specific instructions 420 may depend on the domain and/or or more factors such as, the type of data conversion task, the source content, the configuration of the language model 424, and/or the like.

In some embodiments, the computing system 101 (and/or the task execution service thereof) generates an initial prompt 418 based on the source content 402 and the set of prompt-specific instructions 420. For example, the initial prompt may be generated by performing prompt engineering 416 as described herein, wherein the input for the prompt engineering 416 comprises at least the source content 402 and the set of prompt-specific instructions 420. In some examples, the initial prompt 418 comprises the set of prompt-specific instructions 420, the source content 402, and a prompt example 423. In some examples, the set of prompt-specific instructions 420 identify a set of target fields and a set of model parameters.

By way of example, in a clinical documentation context, the system prompt 421 portion may comprise “Review the below transcript from a health professional and return the response as prescribed in the return data constraints section.” Continuing with the clinical documentation context, an example of a return data constraint 422 may be “REVIEWED WITH (Member, Staff). Another example of a return data constraint 422 in the clinical documentation context may be “CONSTITUTIONAL Fatigue (true, false, NA).”

The set of prompt-specific instructions 420 may comprise specific keywords, phrases, and formatting that the language model 424 (and/or other AI models) has been trained to recognize and respond to appropriately. In some examples, the set of prompt-specific instructions 420 are stored as text strings (e.g., in a structured format such as JSON, YAML, and/or other structured formats). In some examples, the set of prompt-specific instructions 420 may be dynamically generated based on the specific data conversion task, the source content 402, and/or the set of form data objects 428.

In some embodiments, an initial prompt 418 comprises instructions or context provided to a language model 424 to guide the language model’s output generation. An initial prompt 418 may serve as the starting point for interaction with the language model 424, setting the stage for the type of response expected from the language model 424 and/or to elicit a structured output from the language model 424, which may be used to auto-populate a set of form data object(s) associated with a webpage 406. For example, the initial prompt 418 may be designed to elicit a structured data response 426 from the language model 424 that may be used to populate webpage forms, such as used to populate the set of form data objects 428 associated with the webpage 406.

The initial prompt 418 may be a carefully engineered input to the language model 424 that encapsulates the specific requirements for a specific data conversion task. By way of example, in an automatic clinical documentation context, the initial prompt 418 may encapsulate the specific requirements for extracting data from unstructured clinical information such as, for example, unstructured clinical SOAP notes. The initial prompt 418 may comprise instructions for the language model 424 for the specific data conversion task, how to format the output (e.g., JSON, and/or the like), and/or other instructions. For example, the initial prompt 418 may comprise a set of prompt-specific instructions 420, the source content 402, and/or prompt example(s) 423 that serve as few-shot examples.

The initial prompt 418 may be implemented as text that is sent to the language model 424. For example, the initial prompt 418 may be implemented as a string of text that is sent to the language model 424 via an API associated with the language model 424. In some examples, a portion of the initial prompt 418 may be retrieved from the database 412. In some examples, the initial prompt 418 may be dynamically generated based on the source content 402, the data conversion task, and/or the webpage 406.

In some embodiments, the set of target fields comprise a collection of form fields of a structured form (e.g., webpage, content controlled document). For example, the set of target fields may comprise multiple individual form fields, where an individual form field may correspond to a data item that may be extracted from the unstructured source content 402 for populating the individual form field. The set of target fields may be implemented as a data structure, such as an array or list, within the automatic clinical documentation system. The set of target fields may be a factor in computing prompt complexity scores.

In some embodiments, the set of model parameters comprise a collection of configuration settings that define the behavior and characteristics of a language model. The set of model parameters may comprise various numerical values and options that control aspects such as the language model’s size, learning rate, attention mechanisms, and output generation process. The set of model parameters may be implemented as a configuration file or data structure, which may be stored in a format such as JSON or YAML. The set of model parameters may comprise settings such as maximum tokens (e.g., limiting the length of generated text), content window, and/or the like.

The set of model parameters (or portion thereof) may be factors in computing prompt complexity scores. Alternatively, or additionally, in some examples, the set of model parameters may be used in fine-tuning the language model’s performance for the specific data conversion task. By adjusting these parameters, the system may balance factors such as accuracy, creativity, and efficiency in the language model’s outputs. In some examples, the system may use machine learning techniques to dynamically adjust the set of model parameters based on factors such as the structured form represented on the webpage, the type of source content being processed, and/or the like.

In some embodiments, the computing system 101, generates, using the language model 424, a structured data response based on the initial prompt.

In some embodiments, the structured data response comprises an output generated by a language model 424 based on a prompt provided to the language model 424. The structured data response may be used to automatically populate a set of form data objects 428 corresponding to a set of form fields of a webpage 406. The structured data response may be formatted as a JSON object (e.g., key-value data object) comprising key-value pairs, where a key corresponds to a specific form field and the value represents the data to be populated in the specific form field. The structured data response may be generated by a language model 424 through a process involving natural language processing and/or machine learning techniques. When presented with a prompt, the language model 424 may process the source content 402 identified by the prompt to output a structured data response for mapping to form fields of the webpage 406.

In some examples, the language model 424 may process the prompt (e.g., along with the source content 402 thereof) using its attention mechanisms and/or transformer architecture to generate the structured data response. In some examples, a configuration-driven approach may be used to parse the structured data response and map it to the appropriate form data object (e.g., associated with the webpage 406) rendered on a user interface. The structured data response 426 may serve as a bridge between unstructured data and structured documents, enabling efficient and accurate documentation of events, activities, and/or the like that obviates the need for manual data entry and reduces resource inefficiency and/or cost. For example, in a clinical documentation context, the structured data response 426 may serve as a bridge between unstructured clinical information (e.g., clinical conversations, and/or the like) and structured EHR, enabling healthcare providers to efficiently and accurately document patient encounters without manual data entry. This in turn may significantly reduce the time spent on administrative tasks and potentially improves the quality of care.

In some embodiments, the computing system 101, provides the structured data response 426 to auto-populate a set of form data objects 428 (e.g., one or more form data objects 428) associated with the webpage 406. For example, the computing system 101 may cause the set of form data objects 428 to be auto-populated using the structured data response 426. For example, the structured data response 426 may comprise a set of structured key-value data objects that respectively correspond to the set of form data objects 428, where the set of form data objects 428 may respectively correspond to a set of form fields of the webpage. In some examples, the structured data response 426 may be configured in a way that it may be converted to voice/audio content to auto populate the set of form of data objects 428. In some examples, the computing system 101 may convert the structured data response 426 to voice/audio content, and provide the voice/audio content to auto populate the set of form data objects 428.

In some examples, a form data object is auto-populated by determining the form data object within a document object model (DOM) of the webpage based on a key of a structured key-value data object, modifying a field visibility attribute of the form data object, and/or inserting a value of the structured key-value data object to the form data object. In some examples, a form data object of the set of form data objects is stored responsive to a verification input to a corresponding form field of the set of form fields.

In some embodiments, structured key-value data object comprises a data structure for storing structured data response output by a language model 424, where the structured data response is stored as a pair of key and corresponding value. For example, the language model 424 may generate structured data responses in a format, such as a JSON format (or other data interchange format), comprising key-value pairs. The key in the structured key-value data object may represent a form field name and may be used to determine a form data object within a DOM. The value in the structured key-value data object may represent extracted data from the source content 402 that corresponds to the form field.

The structured key-value data object may define a format for organizing output of a language model 424 in a structured format that allows for the set of form data objects 428 rendered on a user interface to be populated. For example, the structured key-value data object objects may be used to dynamically populate form data objects rendered in a user interface. In this regard, the structured key-value data object may provide a clear and consistent way to represent and access data. The structured key-value data object may allow for maintaining data integrity and enabling efficient data processing. For example, the structured key-value data objects may allow for efficient validation of data types, handling of null or missing values, and accurate mapping of the structured data response from the language model 424 to the set of form data objects 428.

In some embodiments, the set of form data objects 428 comprises a collection of structured data elements that correspond to fields in an electronic form such as a structured document implemented and/or represented on the webpage 406. The set of form data objects 428 may be implemented as a data structure, such as an array or a collection of key-value pairs, where a form data object corresponds to a form field. For example, the set of form data objects 428 may be part of and/or defined by a DOM representing form fields such as, for example, HTML form fields. In some examples, the set of form data objects 428 may be automatically populated with values derived from AI-generated responses such as structured data responses output by a language model 424. By way of non-limiting example, in the context of automatic clinical documentation, the set of form data objects 428 may correspond to form fields present in an EHR form such as, for example, electronic SOAP form used to capture patient information.

In some embodiments, the document object model (DOM) comprises a programming interface for structured documents such as, but not limited to HTML and XML structured documents. The DOM may represent the structure of a document. For example, the DOM may represent the structure of a document as a set of form data objects 428, allowing programs and scripts to dynamically access and update the content, structure, and style of the document. In some examples, the DOM may be implemented as a tree structure where a node represents a part of the structured document, such as an element, attribute, or text. In this regard, in some examples, the DOM may represent the structure of a document as a set of form data objects 428 comprising a tree-like hierarchy of objects. By way of example, in web browsers, the DOM may be accessed and/or manipulated using JavaScript.

The DOM may be leveraged to dynamically populate the set of form data objects 428 associated with a webpage 406 with structured data response output from the language model 424. For example, the structured data response may be mapped to form data objects based on the DOM. The DOM may be used for creating an interactive and responsive user interface. The DOM may allow for real-time updates to form fields, dynamic creation or modification of form elements based on user input or AI responses, and efficient event handling for user interactions such as accepting or rejecting the structured data response.

In some embodiments, the field visibility attribute comprises a property associated with a form data object that determines whether the object should be displayed or hidden in the user interface. For example, the field visibility attribute may be a property of a form field class. The field visibility attribute may be used to dynamically control the visibility of form fields based on, for example, various conditions and/or user inputs. In some examples, the field visibility attribute may be implemented as a Boolean flag. In some examples, the field visibility attribute may be implemented as a complex data structure within the DOM.

In some examples, the field visibility attribute may be implemented using JavaScript frameworks (and/or other frameworks), which may use the DOM to efficiently update the user interface based on changes in the underlying data. The field visibility attribute, for example may be used in conjunction with conditional logic to create dynamic, context-sensitive forms. For example, in a clinical documentation context, certain fields may become visible when specific conditions are met, such as when a particular diagnosis is selected or when certain test results are entered. In this regard, the field visibility attribute may enable the creation of more intuitive and streamlined user interfaces. By hiding irrelevant fields, cognitive load on users may be reduced and the risk of data entry errors minimized. The field visibility attribute may allow for the creation of adaptive forms that may cater to different user roles or scenarios within the same application. In some examples, the field visibility attribute may be controlled by server-side logic, with the field visibility attribute being dynamically set based on complex rules or user permissions evaluated on the backend.

In some embodiments, the verification input comprises an input that indicates acceptance or rejection (e.g., by a user) of AI-generated responses such as structured data responses generated by a language model 424. In some examples, the verification input is received from a user via a user interface such as, for example, a user interface rendering the webpage 406. For example, the verification input may be implemented as a user interface element (e.g., a button, a toggle switch, and/or the like) that allows the user to accept/approve or reject the structured data response output by the language model 424 and used to populate the form fields of the webpage 406.

The verification input may serve as a mechanism to ensure the accuracy and appropriateness of structured data response. For example, the verification input may serve as a quality control mechanism to maintain the integrity and/or reliability of the automated content conversion process by allowing a user to review and/or validate the structured data response output by the language model 424. The ability to accept or decline structured data response output may empower the user to maintain control over the structured process while still benefiting from the efficiency gains of automation. By way of example, in an automated clinical documentation context, the verification input may allow healthcare providers to review and validate the AI-generated response (e.g., output of the language model 424), ensuring that no erroneous (e.g., hallucinated) information is entered into the patient’s medical record. In some examples, the verification input may be associated with a feedback mechanism, where users may provide reasons for declining the structured data response output by the language model, which may be used to further improve the language model’s performance.

In some examples, the verification input may trigger a series of actions when received. By way of example, the verification input may be captured by an event listener in the web and processed by an application logic, which may comprise updating the local state of the application and sending an HTTP request to a backend server to record the user’s decision (e.g., accept or reject). The backend server, upon receiving the verification input, may store the information in a database for auditing purposes and/or to use as training data for improving the language model 424.

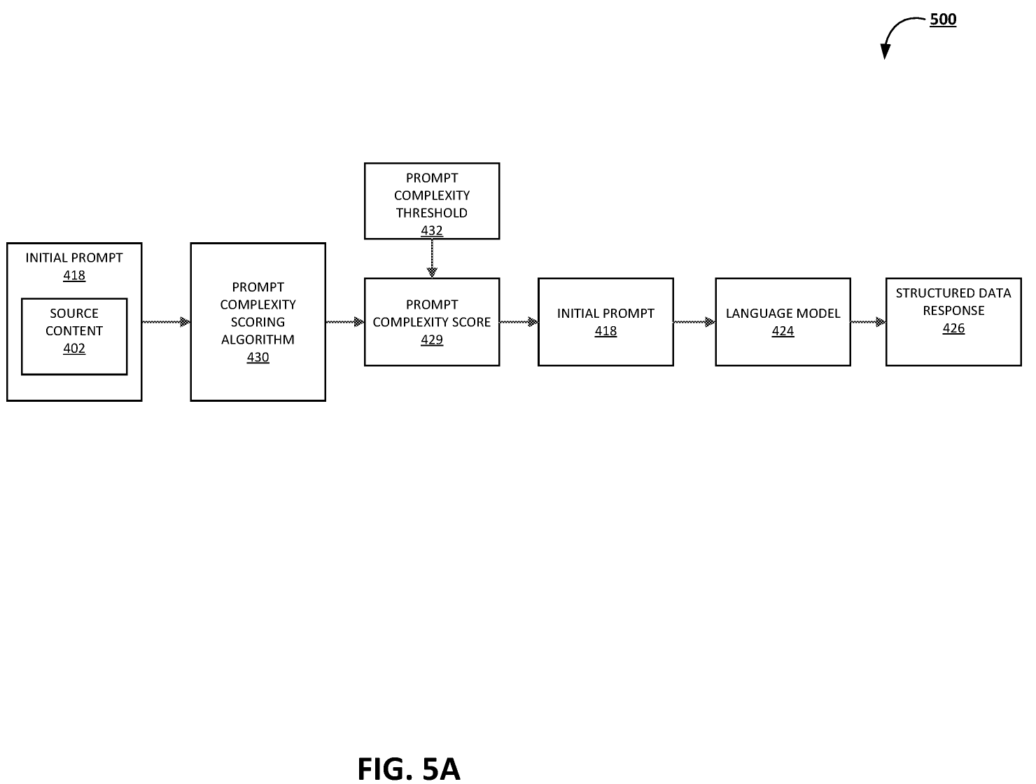

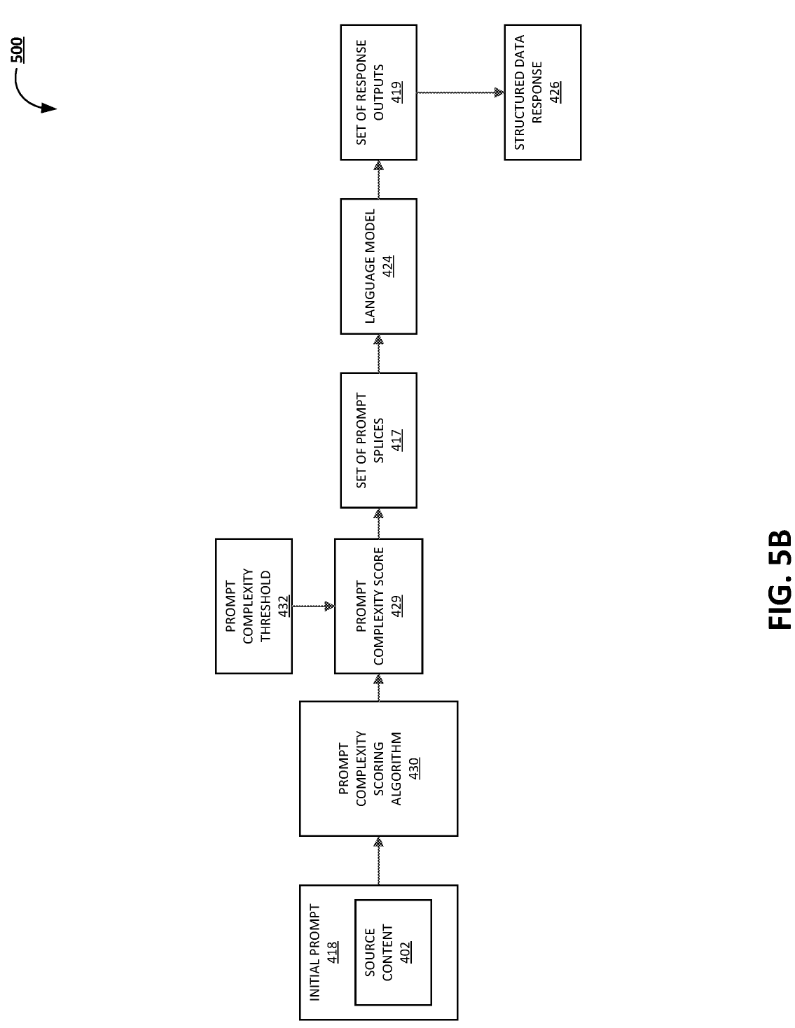

FIGS. 5A and 5B each depict a dataflow diagram 500 of an example prompt engineering technique in accordance with some embodiments of the present disclosure. In some embodiments, in accordance with prompt engineering technique, the computing system 101 determines a prompt complexity score 429 based on the initial prompt 418. For example, the computing system 101 may determine the prompt complexity score 429 based on at least one of a content complexity of the source content, a content length of the source content, a number of the set of target fields, or a token length associated with the set of target fields. In some examples, the computing system 101 may generate the prompt complexity score 429 using a prompt complexity scoring algorithm 430. For example, the computing system 101 may use the prompt complexity scoring algorithm 430 to calculate the prompt complexity score 429 based on at least one of a content complexity of the source content, a content length of the source content, a number of the set of target fields, or a token length associated with the set of target fields.

In some embodiments, the prompt complexity score 429 comprises a value that indicates the complexity of an initial prompt 418. The prompt complexity score 429 may be used to determine efficient processing strategy for handing a data conversion task based on the initial prompt 418. The prompt complexity score 429 may be calculated or otherwise determined using a combination of factors, which may comprise the content complexity of the source content, a content length of the source content (e.g., total words), a number of the set of target fields, a token length associated with the set of target fields, length of the prompt (e.g., measured in tokens or characters), the number of fields or data points requested in the output, the semantic complexity of the prompt, and/or other textual analytics. The prompt complexity score 429 may be used to determine whether to segment the initial prompt 418 into prompt slices 417 for parallel processing or to employ sequential prompt processing. For example, the prompt complexity score 429 may be used to determine and select between sequential execution (e.g., sequential prompt processing) and parallel execution (e.g., parallel prompt processing) with respect to the initial prompt 418. In some examples, if the prompt complexity score 429 does not meet or exceed a predefined prompt complexity threshold, the computing system 101 may select sequential processing (e.g., a prompt processing technique/strategy where the initial prompt 418 is not sliced). In some examples, if the prompt complexity score 429 meets or exceeds the predefined prompt complexity threshold, the computing system 101 may select parallel processing, which may comprise segmenting/slicing the initial prompt 418 into multiple prompt slices 417 and processing the prompt slices 417 concurrently (e.g., in parallel). In some examples, the number of prompt slices 417 may depend on one or more factors, such as the prompt complexity score, type of data conversion task, source content, configuration of the language model 424, and/or the like. Alternatively, or additionally, in some examples, the size of the prompt slices 417 may depend on one or more factors, such as the prompt complexity score, type of data conversion task, source content, configuration of the language model 424, and/or the like. In some examples, the size of each prompt slice in the prompt slices 417 may be the same. In some examples, at least two of the prompt slices 417 may have different sizes.

The prompt complexity score 429 may serve to optimize the system’s performance and resource utilization. By dynamically adjusting the processing strategy based on the complexity of the initial prompt 418, the system may maintain efficient operation even when dealing with highly complex or lengthy initial prompts 418. In some examples, the prompt complexity score 429 may be calculated using natural language processing techniques and/or machine learning models. For example, in some implementations, the prompt complexity score 429 may be calculated using libraries such as Natural Language Toolkit (NLTK) or spaCy to tokenize and analyze the prompt text. As another example, in some implementations, the prompt complexity score 429 may be calculated using machine learning models trained to assess semantic complexity based on features extracted from the text. In this regard, in some example, the prompt complexity scoring algorithm 430 may comprise such natural language processing techniques and/or machine learning models, as described above.

In some embodiments, content complexity comprises one or more items of data indicative of a complexity of the source content 402 based on the data type or other features of the source content 402. Content complexity may serve as a metric to assess the intricacy or difficulty of processing a given piece of information. The content complexity may be one of the factors used to compute the prompt complexity score 429. The content complexity may be calculated using a combination of NLP techniques and/or statistical analysis. For example, the content complexity may be calculated by an algorithm implemented as a Python script running on a server. The algorithm may analyze various aspects of the source content 402, such as sentence structure, vocabulary diversity, and presence of specialized domain terminology. One function of the content complexity assessment may be to optimize the system’s performance and accuracy. By tailoring the processing approach to the complexity of each piece of content, the system may ensure efficient use of computational resources while maintaining high accuracy in extracting and structuring unstructured content.

In some embodiments, content length comprises a length of a source content 402. Content length may be a quantitative measure of the size or extent of a piece of information, typically expressed in terms of character count, word count, or token count. The content length may be calculated using basic string processing functions or specialized natural language processing libraries. In some example implementation, this calculation may be performed using Python libraries such as NLTK (Natural Language Toolkit) or spaCy. These libraries may provide efficient methods for tokenizing text and counting various units of language.

The content length may be one of the factors used to compute the prompt complexity score 429. Different measures of content length may be used depending on the specific use case. For example, it might use character count for quick estimations, word count for more general assessments, or token count when working directly with the language model 424. One function of measuring content length may be to help determine the appropriate processing strategy for a given piece of text. Prompt slicing and parallel processing may be used for longer content to maintain efficiency. Additionally, content length may be used to estimate the computational resources required to process a piece of text, allowing the computing system 101 to allocate resources effectively.

In some example implementations, the computing system 101 may use more sophisticated measures of content length that take into account the information density of the text. For example, the system may assign higher weights to specialized domain terms or complex sentence structures. This could provide a more nuanced assessment of content complexity beyond simple length measurements. Additionally, the system may adapt its length measurement approach based on the specific section of the source content 402 being processed, recognizing that different sections may have different typical lengths and complexities.

In some embodiments, token length comprises the length of the tokens for a target field or the value for the field. Token length may be a measure of the size of a piece of text when broken down into the fundamental units processed by a language model. Token length may be calculated using tokenization algorithms specific to the language model 424 being used. In some examples, the prompt complexity scoring algorithm 430 may comprise such tokenization algorithm. The token length may be used in computing the prompt complexity score 429.

A function of measuring token length may be to optimize the system’s interaction with the language model 424. Many language models have a maximum token limit for their input and output. By accurately measuring token length, the system may ensure that it does not exceed these limits, which could result in truncated or incomplete responses. Additionally, token length is used to balance the workload when performing prompt slicing, ensuring that each prompt slice is of a manageable size for the language model 424 to process efficiently.

In some example implementations, the computing system 101 may use adaptive tokenization strategies that adjust based on the specific content being processed. For example, the system may use different tokenization approaches for highly technical domain terms versus more general language. The computing system 101 system may implement a custom tokenizer trained specifically on domain text, which might provide more efficient tokenization for the particular data conversion task. Furthermore, the token length measurement may be extended to comprise not just the raw count, but also an assessment of the information density of the tokens, potentially allowing for more nuanced prompt slicing and processing strategies.

In some embodiments, the computing system 101 in response to a determination that the prompt complexity score 429 does not exceed a prompt complexity threshold, provides the initial prompt to the language model 424 to receive the structured data response 426.

In some embodiments, the computing system 101 in response to a determination that the prompt complexity score 429 meets or exceeds a prompt complexity threshold, generates a set of prompt slices 417 from the initial prompt 418. For example, the computing system 101 may determine an instruction subset of the set of prompt-specific instructions 420 based on a prompt token limit, and generate a prompt slice of the set of prompt slices 417 based on the instruction subset and the source content 402. In some examples, the computing system 101 provides the set of prompt slices 417 to the language model in parallel.

In some embodiments, the prompt complexity threshold 432 comprises a value used to determine whether prompt slicing should be employed for processing unstructured input, such unstructured source content 402. The prompt complexity threshold 432 may serve as a decision point in the automated content conversion process. For example, the prompt complexity threshold 432 may be compared against a prompt complexity score 429 to decide between sequential and parallel prompt processing strategies, wherein the parallel prompt processing strategy comprise generating the set of prompt slices 417 from the initial prompt 418 and executing the set of prompt slices 417 in parallel. The prompt complexity threshold 432 may be implemented as a numerical value stored in a database, such as the configuration database 412.

In some embodiments, the set of prompt slices 417 comprises a collection of prompts derived from a single prompt (e.g., initial prompt 418). For example, the set of prompt slices 417 may comprise smaller prompts derived from an initial prompt 418 associated with a prompt complexity score 429 that meets or exceeds the prompt complexity threshold 432. The process of generating the set of prompt slices 417 may comprise segmenting the initial prompt 418 into smaller, more manageable segments. In an example implementation, the process of generating the set of prompt slice comprises segmenting the return data constraints in the initial prompt 418 to multiple segments and generating a prompt slice comprising each segment. In some examples, natural language processing techniques may be leveraged to generate the set of prompt slices 417. For example, natural language processing techniques may be used to identify logical break points in the prompt while ensuring that each prompt slice maintains sufficient context to be processed independently. In some examples, the prompt slices 417 comprise a common system prompt 421 and different return data constraints. For example, a prompt slice 417 may comprise the system prompt 421 and a subset of the set of return data constraints 422 that collectively form the instruction subset for the prompt slice 417. For example, the process of generating the set of prompt slices 417 may comprise segmenting the initial set of return data constraints 422 in the initial prompt 418 into a plurality of subsets of return data constraint, where a subset of return data constraint may comprise a portion of the initial set of return data constraints 422.

In some examples, advanced text segmentation algorithms and/or machine learning models (e.g., trained on domain-specific data) may be leveraged to identify optimal slicing points. In some example implementations, libraries such as TensorFlow or PyTorch may be leveraged and may be combined with custom logic to ensure the prompt slices 417 are balanced in terms of complexity and content. The set of prompt slices 417 may be processed in parallel, with each prompt slice 417 being sent to the language model 424 independently. In some examples, the parallel processing may be implemented using asynchronous programming techniques to manage multiple concurrent API calls to the language model 424.

This approach may allow the system to handle complex data conversion tasks more efficiently by breaking them down into smaller, manageable chunks that may be processed in parallel. The use of prompt slices 417 allows the computing system 101 to handle complex prompts more efficiently by distributing the workload across multiple processing units or API calls. This may significantly reduce the overall processing time for complex prompts, especially when dealing with prompts that exceed the token limit of the language model 424 or require extensive computation. The set of prompt slices 417 may enable the system to maintain high performance and responsiveness even when dealing with extremely complex or lengthy prompts and/or complex data conversion tasks. The set of prompt slices 417 may allow the system to overcome limitations in the language model’s input size while still leveraging its capabilities for generating accurate and contextually relevant structured data responses. In some examples, the prompt slicing technique may comprise adaptive prompt slicing strategies that adjust based on real-time system load or the language model performance metrics.

In some embodiments, the instruction subset comprises a portion of prompt-specific instructions provided to a language model 424. The instruction subset may be generated as part of a prompt engineering process used by the content conversion process. The instruction subset may comprise a carefully crafted text string that forms part of a larger prompt provided to the language model 424. For example, the instruction subset may comprise a system prompt 421 and a subset of the set of return data constraints 422. The text string may be stored in a database, such as a relational database (e.g., PostgreSQL), which allows for efficient retrieval and modification of instruction subsets as needed. An instruction subset may correspond to a particular portion of the set of form data objects 428 renderable on a webpage 406. In some examples, the system may retrieve the appropriate instruction subset based on the specific section of the source content 402 being analyzed. The instruction subset may then be combined with the unstructured source content 402 and/or few shot example(s) 423 to form a prompt slice 417.

The instruction subset may function to guide the language model 424 in generating structured, consistent outputs from unstructured data. By providing specific instructions for each section of the source content 402, the system may ensure that the language model’s responses adhere to the required format and comprises the appropriate information for populating the set of form data objects and in the desired format. For example, the primary function of the instruction subset may be to guide the language model 424 in generating structured, consistent outputs from unstructured source content.

In some implementations, the system may dynamically generate the instruction subsets as opposed to using pre-defined subsets. This approach may allow for more flexible handling of unusual or complex scenarios. Additionally, the system could be adapted to use multiple instruction subsets for a single prompt slice 417, allowing for more nuanced control over the language model’s output.

In some embodiments, the computing system 101 provides the set of prompt slices 417 to the language model 424 to receive a set of response outputs 419 respectively corresponding to the set of prompt slices 417.

In some embodiments, the set of response outputs 419 comprise a collection of outputs generated by a language model 424. For example, the set of response outputs 419 may comprise individual responses, where a response output corresponds to a particular prompt slice from the set of prompt slices 417 provided to the language model 424. The set of response outputs 419 may serve as outputs of an intermediate step of a data conversion task for transforming unstructured data into structured data for auto-populating form data object(s). By way of non-limiting example, the set of response outputs 419 may serve as outputs of an intermediate step in transforming unstructured clinical notes into structured data suitable for populating EHRs implemented on a webpage 406. In some examples, the set of response outputs 419 may undergo further processing, such as, but not limited to, error detection, correction, formatting, and/or mapping to specific for data objects (e.g., corresponding to form fields) rendered in a user interface.

In some embodiments, the computing system 101 generates the structured data response based on the set of response outputs 419.

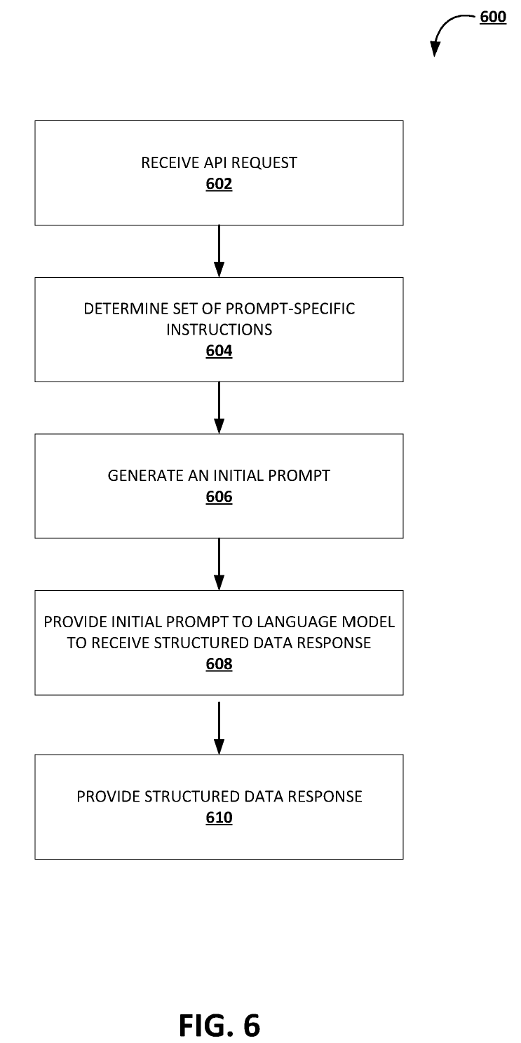

FIG. 6 is a flowchart diagram of an example automated content conversion process 600 in accordance with some embodiments of the present disclosure. The flowchart diagram depicts an improved content conversion technique (e.g., in terms of accuracy) that applies a data conversion approach to extract relevant data from unstructured source content as a structured outputs that allows for reliable mapping to form fields of a structured form, which may be implemented as a webpage. The process 600 may be implemented by one or more computing devices, entities, and/or systems described herein. For example, via the various steps/operations of the process 600, the computing system 101 may calculate a prompt complexity score for an initial prompt associated with the structured form, where the prompt complexity score may serve as a basis for deciding between sequential prompt processing or parallel prompt processing. By doing so, the process 600 improve computer functionality by improving the processing accuracy of the content conversion and improving computing efficiency relative to traditional processing techniques.

In some embodiments, the process 600 comprises, at operation 602, receiving a request. In some embodiments, the request may be an API request, CLI request or other form of request. For example, the computing system 101 may receive an API request, CLI request, or other form of request that identifies source content and a data conversion task for a language model and a webpage. For example, the source content may comprise unstructured text for populating a structured form implemented as the webpage. In some examples, the computing system 101 may authenticate the request in response to receiving the request. For example, in embodiments, where the request is an API request, the computing system 101 may authenticate the API request in response to receiving the API request. In some examples, the computing system 101 may parse the request (e.g., API request, CLI request, or other form of request) and check it against configuration information, which may be maintained in a configuration database such as a relational database.

In some embodiments, the process 600 comprises, at operation 604, determining a set of prompt-specific instructions for the language model. For example, the computing system 101 may determine a set of prompt-specific instructions for the language model based on the data conversion task identified in the request, where the set of prompt-specific instructions comprises one or more prompt-specific instructions. For example, the set of prompt-specific instructions may comprise part of configuration information for the data conversion task for interacting with the language model. The configuration information, for example, may comprise the set of prompt-specific instructions, model parameters (e.g., context window, maximum tokens, and/or the like), prompt examples, and/or other configuration information for interacting with the language model.

In some embodiments, the process 600 comprises, at operation 606, generating an initial prompt. For example, the computing system 101 may generate an initial prompt based on the source content and the set of prompt-specific instructions. In some examples, the initial prompt comprises the set of prompt-specific instructions, the source content, and a prompt example. In some examples, the set of prompt-specific instructions may comprise a system prompt and a set of return data constraints, wherein the system prompt comprises text that directs the language model to perform a data conversion task based on the source content 402 and provide an output in accordance with the set of return data constraints. For example, the set of return data constraints may serve as a blueprint for the desired structured output from the language model. Alternatively, or additionally, in some examples, the set of prompt-specific instructions identify a set of target fields and a set of model parameters.

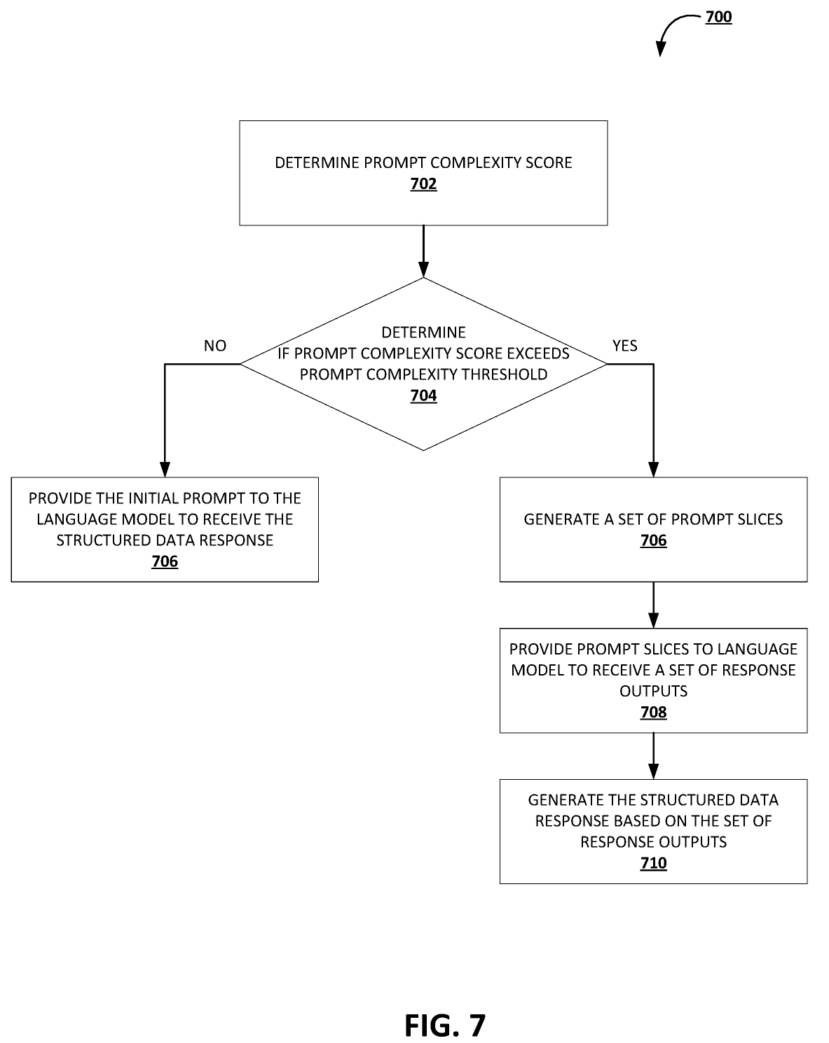

In some embodiments, the process 600 comprises, at operation 608, generating, using a generative model, a structured data response based on the initial prompt. For example, the computing system 101 may provide the initial prompt to the language model to receive the structured data response. In some examples, the structured data response may be formatted as a JSON object (e.g., key-value data object) comprising key-value pairs, where a key corresponds to a specific form field and the value represents the data to be populated in the specific form field. In some examples, as described in FIG. 7, generating the structured data response may comprise determining between a sequential prompt processing technique/strategy or parallel prompt processing technique/strategy.

In some embodiments, the process 600 comprises, at operation 610, providing the structured data response to auto-populate the form fields of the structured form. For example, the computing system 101 may provide the structured data response to auto-populate a set of form data objects associated with the webpage representing the structured form. For example, the computing system 101 may cause the set of form data objects to be auto-populated using the structured data response. In some examples, a structured data response may comprise a set of structured key-value data objects that respectively correspond to the set of form data objects, where the set of form data objects may respectively correspond to a set of form fields of the webpage. In some examples, a form data object may be auto-populated by determining the form data object within a DOM of the webpage based on a key of a structured key-value data object, modifying a field visibility attribute of the form data object, and/or inserting a value of the structured key-value data object to the form data object. In some examples, a form data object of the set of form data objects is stored responsive to a verification input to a corresponding form field of the set of form fields.

FIG. 7 is a flowchart diagram of an example prompt engineering process 700 in accordance with some embodiments of the present disclosure. The flowchart diagram depicts an improved prompt processing for content conversion (e.g., in terms of accuracy) that applies a prompt complexity scoring algorithm to the structured form (e.g., webpage) and/or the initial prompt associated with the data conversion task for the structured form to determine if the initial prompt should be segmented into multiple prompts for parallel processing. The process 700 may be implemented by one or more computing devices, entities, and/or systems described herein. For example, via the various steps/operations of the process 700, the computing system 101 may calculate a prompt complexity score for an initial prompt associated with the structured form, where the prompt complexity score may serve as a basis for deciding between sequential prompt processing or parallel prompt processing. By doing so, the process 700 improve computer functionality by improving the processing accuracy of the content conversion and improving computing efficiency relative to traditional processing techniques.

In some embodiments, the process 700 comprises, at operation 702, determining a prompt complexity score for an initial prompt. For example, the computing system 101 may determine the prompt complexity score based on at least one of a content complexity of the source content, a content length of the source content, a number of the set of target fields, or a token length associated with the set of target fields.

In some embodiments, the process 700 comprises, at operation 704, comparing the prompt complexity score to a prompt complexity threshold. For example, the computing system 101 may compare the prompt complexity score to the prompt complexity threshold to determine if the prompt complexity score exceeds the prompt complexity threshold.

In some embodiments, the process 700 comprises, at operation 706, providing the initial prompt to the language model to receive the structured data response if the prompt complexity score 429 does not exceed the prompt complexity threshold, otherwise, the process 700, at operation 702 comprises if the prompt complexity score meets or exceeds the prompt complexity threshold, generating a set of prompt slices from the initial prompt and performing operations 708-708 described below. For example, the computing system 101 may provide the initial prompt to the language model to receive the structured data response if determined by the computing system 101 that the prompt complexity score does not exceed a prompt complexity threshold, otherwise the computing system 101 may generate a set of prompt slices from the initial prompt and perform operations 708-710 if the computing system 101 determines that the prompt complexity score 429 meets or exceeds the prompt complexity threshold.

In some embodiments, the process 700 comprises, at operation 708, providing the set of prompt slices to the language model to receive a set of response outputs respectively corresponding to the set of prompt slices. For example, the computing system 101 may provide the set of prompt slices to the language model to receive a set of response outputs respectively corresponding to the set of prompt slices.

In some embodiments, the process 700 comprises, at operation 710, generating the structured data response based on the set of response outputs. For example, the computing system 101 may generate the structured data response based on the set of response outputs.

Some techniques of the present disclosure enable the generation of action outputs that may be performed to initiate one or more real world actions to achieve real-world effects. The techniques of the present disclosure may be used, applied, and/or otherwise leveraged to facilitate resolution of problems associated with downstream processes of a workflow that relies on information from various documents. In some examples, the raw features set and/or segment classification of the present disclosure may trigger action outputs (e.g., through control instructions) to automate workflow actions, such as alerts, notifications, and/or the like. The action outputs may control various aspects of a client device, such as the display, transmission, and/or the like of data reflective of an alert, and/or the like. The alert may be automatically communicated to a user and/or may be used to initiate an automated workflow, robotic action, and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

Some techniques of the present disclosure enable the generation of action outputs that may be performed to initiate one or more real world actions to achieve real-world effects. The techniques of the present disclosure may be used, applied, and/or otherwise leveraged to leveraged to facilitate resolution of problems associated with downstream processes of a workflow that relies on information from unstructured data. In some examples, the structured data responses and/or auto-populated form data object of the present disclosure may trigger action outputs (e.g., through control instructions) to automate workflow actions, such as alerts, notifications, and/or the like. The action outputs may control various aspects of a client device, such as the display, transmission, and/or the like of data reflective of an alert, and/or the like. The alert may be automatically communicated to a user and/or may be used to initiate an automated workflow, robotic action, and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model’s architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model’s architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model’s parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: receiving, by one or more processors, an API request and that identifies source content and a data conversion task for a language model and a webpage; determining, by the one or more processors, a set of prompt-specific instructions based on the data conversion task, wherein the set of prompt-specific instructions comprises one or more prompt-specific instructions; generating, by the one or more processors and using a task execution service, an initial prompt based on the source content and the set of prompt-specific instructions; generating, by the one or more processors and using a generative model, a structured data response based on the initial prompt; and providing, by the one or more processors, the structured data response to auto-populate one or more form data objects associated with the webpage.

Example 2. The computer-implemented method of example 1, wherein a structured data response comprises a set of structured key-value data objects that respectively correspond to the one or more form data objects.

Example 3. The computer-implemented method of example 2, wherein the set of form data objects respectively correspond to a set of form fields of the webpage and a form data object is auto-populated by (i) determining the form data object within a document object model of the webpage based on a key of a structured key-value data object, (ii) modifying a field visibility attribute of the form data object, (iii) inserting a value of the structured key-value data object to the form data object.

Example 4. The computer-implemented method of example 3, wherein a form data object of the set of form data objects is stored responsive to a verification input to a corresponding form field of the set of form fields.

Example 5. The computer-implemented method of any of the preceding examples, wherein the initial prompt comprises the set of prompt-specific instructions, the source content, and a prompt example, and the set of prompt-specific instructions identify a set of target fields and a set of model parameters.

Example 6. The computer-implemented method of example 5, further comprising: determining a prompt complexity score based on the initial prompt; in response to a determination that the prompt complexity score meets or exceeds a prompt complexity threshold, generating a set of prompt slices from the initial prompt; providing the set of prompt slices to the language model to receive a set of response outputs respectively corresponding to the set of prompt slices; and generating the structured data response based on the set of response outputs.

Example 7. The computer-implemented method of example 6, wherein generating the set of prompt slices from the initial prompt comprises: determining an instruction subset of the set of prompt-specific instructions based on a prompt token limit; and generating a prompt slice of the set of prompt slices based on the instruction subset and the source content.

Example 8. The computer-implemented method of any of examples 6-7, wherein the set of prompt slices is provided to the language model in parallel.

Example 9. The computer-implemented method of any of examples 6-8, wherein the prompt complexity score is based on at least one of a content complexity of the source content, a content length of the source content, a number of the set of target fields, or a token length associated with the set of target fields.

Example 10. The computer-implemented method of an of the preceding examples, further comprising: determining a prompt complexity score based on the initial prompt; and in response to a determination that the prompt complexity score does not exceed a prompt complexity threshold, providing the initial prompt to the language model to receive the structured data response.

Example 11. A system comprising: one or more processors; and one or more memories storing processor-executable instructions that, when executed by the one or more processors, cause the one or more processors to perform operations comprising: receiving an API request that identifies source content and a data conversion task for a language model and a webpage; determining a set of prompt-specific instructions based on the data conversion task, wherein the set of prompt-specific instructions comprises one or more prompt-specific instructions; generating an initial prompt based on the source content and the set of prompt-specific instructions; generating, using a generative model, a structured data response based on the initial prompt; and providing the structured data response to auto-populate one or more form data objects associated with the webpage.

Example 12. The system of example 11, wherein a structured data response comprises a set of structured key-value data objects that respectively correspond to the one or more form data objects.

Example 13. The system of example 12, wherein the set of form data objects respectively correspond to a set of form fields of the webpage and a form data object is auto-populated by (i) determining the form data object within a document object model of the webpage based on a key of a structured key-value data object, (ii) modifying a field visibility attribute of the form data object, (iii) inserting a value of the structured key-value data object to the form data object.

Example 14. The system of example 13, wherein a form data object of the set of form data objects is stored responsive to a verification input to a corresponding form field of the set of form fields.

Example 15. The system of any of examples 11-14, wherein the initial prompt comprises the set of prompt-specific instructions, the source content, and a prompt example, and the set of prompt-specific instructions identify a set of target fields and a set of model parameters.

Example 16. The system of example 15, further comprising: determining a prompt complexity score based on the initial prompt; in response to a determination that the prompt complexity score meets or exceeds a prompt complexity threshold, generating a set of prompt slices from the initial prompt; providing the set of prompt slices to the language model to receive a set of response outputs respectively corresponding to the set of prompt slices; and generating the structured data response based on the set of response outputs.

Example 17. The system of example 16, wherein generating the set of prompt slices from the initial prompt comprises: determining an instruction subset of the set of prompt-specific instructions based on a prompt token limit; and generating a prompt slice of the set of prompt slices based on the instruction subset and the source content.

Example 18. The system of any of examples 16-17, wherein the set of prompt slices is provided to the language model in parallel.

Example 19. The system of any of examples 16-18, wherein the prompt complexity score is based on at least one of a content complexity of the source content, a content length of the source content, a number of the set of target fields, or a token length associated with the set of target fields.

Example 20. One or more non-transitory computer-readable media storing processor-executable instructions that, when executed by one or more processors, cause the one or more processors to perform operations comprising: receiving an API request that identifies source content and a data conversion task for a language model and a webpage; determining a set of prompt-specific instructions based on the data conversion task, wherein the set of prompt-specific instructions comprises one or more prompt-specific instructions; generating an initial prompt based on the source content and the set of prompt-specific instructions; generating, using a generative model, a structured data response based on the initial prompt; and providing the structured data response to auto-populate one or more form data objects associated with the webpage.

Example 21. The computer-implemented method of example 1, wherein the method further comprises training the language model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 11, wherein the one or more processors are further configured to train the language model.

Example 25. The computing system of example 24, wherein the one or more processors are comprised in a first computing entity; and the language model is trained by one or more other processors comprised in a second computing entity.

Example 26. The one or more non-transitory computer-readable storage media of example 20, wherein the instructions further cause the one or more processors to train the language model.

Example 27. The one or more non-transitory computer-readable storage media of example 26, wherein the one or more processors are comprised in a first computing entity; and the language model is trained by one or more other processors comprised in a second computing entity.

What is claimed is:

1. A computer-implemented method comprising:
receiving, by one or more processors, an API request and that identifies source content and a data conversion task for a language model and a webpage;
determining, by the one or more processors, a set of prompt-specific instructions based on the data conversion task, wherein the set of prompt-specific instructions comprises one or more prompt-specific instructions;
generating, by the one or more processors and using a task execution service, an initial prompt based on the source content and the set of prompt-specific instructions;
generating, by the one or more processors and using a generative model, a structured data response based on the initial prompt; and
providing, by the one or more processors, the structured data response to auto-populate one or more form data objects associated with the webpage.

2. The computer-implemented method of claim 1, wherein a structured data response comprises a set of structured key-value data objects that respectively correspond to the one or more form data objects.

3. The computer-implemented method of claim 2, wherein the one or more form data objects respectively correspond to a set of form fields of the webpage and a form data object is auto-populated by (i) determining the form data object within a document object model of the webpage based on a key of a structured key-value data object, (ii) modifying a field visibility attribute of the form data object, (iii) inserting a value of the structured key-value data object to the form data object.

4. The computer-implemented method of claim 3, wherein a form data object of the one or more form data objects is stored responsive to a verification input to a corresponding form field of the set of form fields.

5. The computer-implemented method of claim 1, wherein the initial prompt comprises the set of prompt-specific instructions, the source content, and a prompt example, and the set of prompt-specific instructions identify a set of target fields and a set of model parameters.

6. The computer-implemented method of claim 5, further comprising:
determining a prompt complexity score based on the initial prompt;
in response to a determination that the prompt complexity score meets or exceeds a prompt complexity threshold, generating a set of prompt slices from the initial prompt;
providing the set of prompt slices to the language model to receive a set of response outputs respectively corresponding to the set of prompt slices; and
generating the structured data response based on the set of response outputs.

7. The computer-implemented method of claim 6, wherein generating the set of prompt slices from the initial prompt comprises:
determining an instruction subset of the set of prompt-specific instructions based on a prompt token limit; and
generating a prompt slice of the set of prompt slices based on the instruction subset and the source content.

8. The computer-implemented method of claim 6, wherein the set of prompt slices is provided to the language model in parallel.

9. The computer-implemented method of claim 6, wherein the prompt complexity score is based on at least one of a content complexity of the source content, a content length of the source content, a number of the set of target fields, or a token length associated with the set of target fields.

10. The computer-implemented method of claim 1, further comprising:
determining a prompt complexity score based on the initial prompt; and
in response to a determination that the prompt complexity score does not exceed a prompt complexity threshold, providing the initial prompt to the language model to receive the structured data response.

11. A system comprising:
one or more processors; and
one or more memories storing processor-executable instructions that, when executed by the one or more processors, cause the one or more processors to perform operations comprising:
receiving an API request that identifies source content and a data conversion task for a language model and a webpage;
determining a set of prompt-specific instructions based on the data conversion task, wherein the set of prompt-specific instructions comprises one or more prompt-specific instructions;
generating an initial prompt based on the source content and the set of prompt-specific instructions;
generating, using a generative model, a structured data response based on the initial prompt; and
providing the structured data response to auto-populate one or more form data objects associated with the webpage.

12. The system of claim 11, wherein a structured data response comprises a set of structured key-value data objects that respectively correspond to the one or more form data objects.

13. The system of claim 12, wherein the one or more form data objects respectively correspond to a set of form fields of the webpage and a form data object is auto-populated by (i) determining the form data object within a document object model of the webpage based on a key of a structured key-value data object, (ii) modifying a field visibility attribute of the form data object, (iii) inserting a value of the structured key-value data object to the form data object.

14. The system of claim 13, wherein a form data object of the one or more form data objects is stored responsive to a verification input to a corresponding form field of the set of form fields.

15. The system of claim 11, wherein the initial prompt comprises the set of prompt-specific instructions, the source content, and a prompt example, and the set of prompt-specific instructions identify a set of target fields and a set of model parameters.

16. The system of claim 15, further comprising:
determining a prompt complexity score based on the initial prompt;
in response to a determination that the prompt complexity score meets or exceeds a prompt complexity threshold, generating a set of prompt slices from the initial prompt;
providing the set of prompt slices to the language model to receive a set of response outputs respectively corresponding to the set of prompt slices; and
generating the structured data response based on the set of response outputs.

17. The system of claim 16, wherein generating the set of prompt slices from the initial prompt comprises:
determining an instruction subset of the set of prompt-specific instructions based on a prompt token limit; and
generating a prompt slice of the set of prompt slices based on the instruction subset and the source content.

18. The system of claim 16, wherein the set of prompt slices is provided to the language model in parallel.

19. The system of claim 16, wherein the prompt complexity score is based on at least one of a content complexity of the source content, a content length of the source content, a number of the set of target fields, or a token length associated with the set of target fields.

20. One or more non-transitory computer-readable media storing processor-executable instructions that, when executed by one or more processors, cause the one or more processors to perform operations comprising:
receiving an API request that identifies source content and a data conversion task for a language model and a webpage;
determining a set of prompt-specific instructions based on the data conversion task, wherein the set of prompt-specific instructions comprises one or more prompt-specific instructions;
generating an initial prompt based on the source content and the set of prompt-specific instructions;
generating, using a generative model, a structured data response based on the initial prompt; and
providing the structured data response to auto-populate one or more form data objects associated with the webpage.
